(19) United States
(12) Patent Application Publication
(10) Pub. No.: US 2019/0016287 A1
(43) Pub. Date: Jan. 17, 2019

(54) Security System for a Transportation Vehicle

(71) Applicant: Bob Barker Company, Inc., Fuquay-Varina, NC (US)

(72) Inventor: Jeremy Amidon, Raleigh, NC (US)

(21) Appl. No.: 16/032,436

(22) Filed: Jul. 11, 2018

Related U.S. Application Data
(60) Provisional application No. 62/531,449, filed on Jul. 12, 2017.

(51) Int. Cl. B60R 21/12; B60P 3/03; B60R 21/02; B60N 2/24; B60N 2/01

(52) U.S. Cl. CPC B60R 21/12; B60P 3/03; B60N 2/01; B60N 2/242; B60R 21/026

(57) ABSTRACT

A security system configured to be installed within an interior of a transportation vehicle to separate persons into different secure holding areas. The secure holding areas are configured to be divided along the length of the vehicle with a first one of the secure holding areas positioned in front of the other secure holding area. At least one of the secure holding areas is further configured to have access doors on each lateral side. This facilitates loading and unloading persons into and out of the secure holding area. The design further segregates the secure holding areas.

This application claims the benefit of U.S. Provisional Application Ser. No. 62/531,449 filed Jul. 12, 2017, the disclosure of which is incorporated herein by reference in its entirety.

### BACKGROUND

Correctional institutions, such as prisons and detention facilities, are required to periodically transport persons. This may occur when transporting persons between correctional institutions, for judicial hearings, for medical events, and a wide variety of other reasons.

Specially designed vehicles are used for transporting persons. These vehicles include the necessary security infrastructure to safely transport the persons and also prevent their escape. The vehicles are also designed to ensure the safety of the security personnel overseeing the transportation. A drawback of some designs is the vehicles may place a security guard in a potentially dangerous situation, particularly during loading and unloading of the persons. These situations provide the potential for a person to contact the guard and potentially injure them. This may also allow the person to escape from the vehicle.

FIG. 1 schematically illustrates a vehicle 50 with an interior enclosure configured for transporting persons. The vehicle 50 includes a front 58, rear 59, and lateral sides 57. A side door 51 along one of the lateral sides 57 and a back door 52 at the rear 59 provide access into an out of the interior space. To load a person into a first interior area 53, a guard may have to initially enter into the area 53 before the person. This may occur when the person is in a wheelchair or otherwise not able to load themselves into the area 53. In this instance, the person is positioned between the guard and the door 51. This is a potentially dangerous situation for the guard as they are required to move past the person to exit from the area 53. The person may have the opportunity to contact the guard, or block the guard from exiting through the door 51.

Another issue with enclosures is the need to segregate the persons into the different areas. For example in FIG. 1, persons in the first interior area 53 may need to be segregated from persons in the second interior area 54. Segregating the different areas further constricts the space for a security guard to move within the interior thus increasing the potential for the security guard to move within close proximity to the person during loading and unloading.

### SUMMARY

The present application discloses security systems and methods of mounting the security systems within the interior of a vehicle. The security systems provide for transporting persons in a secure manner.

One aspect is directed to a security system for use within a vehicle that includes first and second side doors on opposing lateral sides of the vehicle and a rear door on a rear of the vehicle. The security system includes a front wall that extends between and is sized to contact against the opposing lateral sides of the vehicle at a first longitudinal position in front of the first and second side doors. A rear wall extends between and is sized to contact against the opposing lateral sides of the vehicle at a second longitudinal position behind the first and second side doors. A first holding area is formed between the front wall and the rear wall. The first holding area includes a first open lateral side that aligns with the first side door and a second open lateral side that aligns with the second side door. A second holding area is formed between the rear wall and the rear door of the vehicle. The second holding area includes an open rear that aligns with the rear of the vehicle. The first holding area is independent from the second holding area to isolate a first person in the first holding area from a second person in the second holding area.

In one aspect, the security system also includes first and second benches that extend longitudinally within one of the first and second holding areas.

In one aspect, the first bench extends along a first lateral side of the vehicle and the second bench extends along a second lateral side of the vehicle with the first and second benches being spaced apart with an aisle formed between the first and second benches.

In one aspect, the first and second benches are each positioned along a longitudinal center of the vehicle in a back-to-back orientation with the first bench facing the first lateral side of the vehicle and the second bench facing the second lateral side of the vehicle.

In one aspect, the security system also includes a longitudinal wall positioned between the first and second benches with the longitudinal wall extending between a floor and a ceiling of one of the first and second holding areas.

In one aspect, the security system also includes mounts connected to a floor of the vehicle and straps that extend from the mounts to secure a wheelchair within one of the first and second holding areas.

In one aspect, the security system also includes at least one folding bench positioned adjacent to the mounts and the straps with the folding bench movable between a stowed orientation and an extended orientation.

One aspect is directed to a method of installing a security system within a vehicle. The method includes attaching a front wall within an interior of the vehicle at a first longitudinal position that is in front of first and second side doors of opposing lateral sides of the vehicle and contacting the front wall against the opposing lateral sides of the vehicle. The method includes attaching a rear wall within the interior of the vehicle at a second longitudinal position that is behind the first and second side doors and contacting the rear wall against the opposing lateral sides of the vehicle. The method includes forming a first holding area between the front wall and the rear wall and aligning a first open lateral side with the first side door and aligning a second open lateral side with the second side door. The method also includes forming a second holding area between the rear wall and a rear of the vehicle and aligning an open side with a rear door on the rear of the vehicle.

In one aspect, the method also includes positioning the rear wall across the interior of the vehicle and isolating the first holding area from the second holding area.

In one aspect, the method also includes attaching a longitudinal wall between the front wall and the rear wall and isolating a first section of the first holding area that faces towards the first open lateral side from a second section of the first holding area that faces towards the second open lateral side.

In one aspect, the method also includes attaching a first bench to the longitudinal wall in the first section of the first holding area and attaching a second bench to the longitudinal wall in the second section of the second holding area.

In one aspect, the method also includes connecting mounts and straps to a floor of the vehicle within the second holding area with the mount and straps configured to secure a wheelchair within the second holding area.

In one aspect, the method includes forming the first holding area to be open between the first and second open lateral sides to prevent a security personnel from becoming trapped within the first holding area.

In one aspect, the method also includes attaching a first bench to the first lateral side of the vehicle within the second holding area and attaching a second bench to the second lateral side of the vehicle within the second holding area and forming an open aisle between the first and second benches.

In one aspect, the method also includes aligning each of the first and second benches transverse to the rear of the vehicle.

One aspect is directed to a method of installing a security system within an interior of a vehicle. The method includes forming a first holding area in the vehicle and aligning a first open lateral side of the first holding area with a first lateral side door of the vehicle and a second open lateral side of the first holding area with a second lateral side door of the vehicle. The method includes forming a second holding area in the vehicle behind the first holding area with the second holding area having an open rear side that aligns with a rear door of the vehicle and the second holding area being isolated from the first holding area by a rear wall. The method also includes using the lateral side walls of the vehicle as lateral side walls of each of the first and second holding areas.

In one aspect, forming the first holding area includes attaching a front wall across the interior of the vehicle and attaching the rear wall across the interior of the vehicle with the front and rear walls being longitudinally spaced apart.

In one aspect, the method also includes mounting first and second benches in the first holding area with the first bench facing towards the first lateral side door of the vehicle and the second bench facing towards the second lateral side door of the vehicle.

In one aspect, the method also includes positioning an intermediate wall between the first and second benches and attaching the intermediate wall to each of the front wall and the rear wall.

In one aspect, the method also includes positioning a first bench against one of the lateral side walls in the second holding area and positioning a second bench against the other of the lateral side walls in the second holding area.

The various aspects of the various embodiments may be used alone or in any combination, as is desired.

### BRIEF DESCRIPTION OF THE DRAWINGS

FIG. 1 is a schematic view of prior art vehicle with security enclosures.

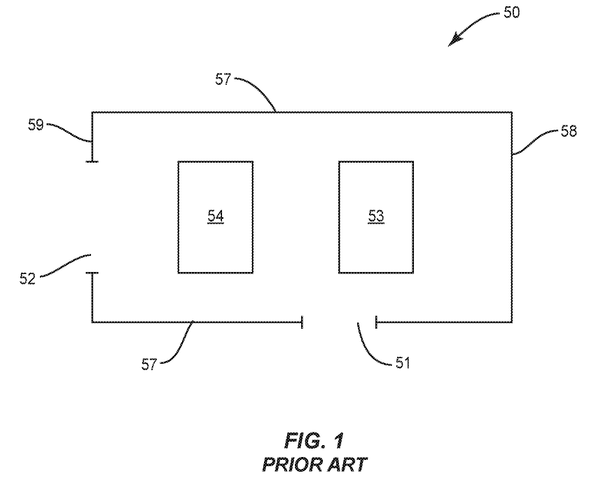

FIG. 2 is a schematic view of a system positioned within an interior of a vehicle.

FIG. 3 is a schematic view of a system positioned within an interior of a vehicle.

### DETAILED DESCRIPTION

The present application is directed to a security system configured to be installed within an interior of a transportation vehicle to separate persons into different secure holding areas. The secure holding areas are configured to be divided along the longitudinal length of the vehicle with a first one of the secure holding areas positioned in front of the other secure holding area. At least one of the secure holding areas is further configured to have access doors on each lateral side. This facilitates loading and unloading persons into and out of the secure holding area. The design further segregates the secure holding areas.

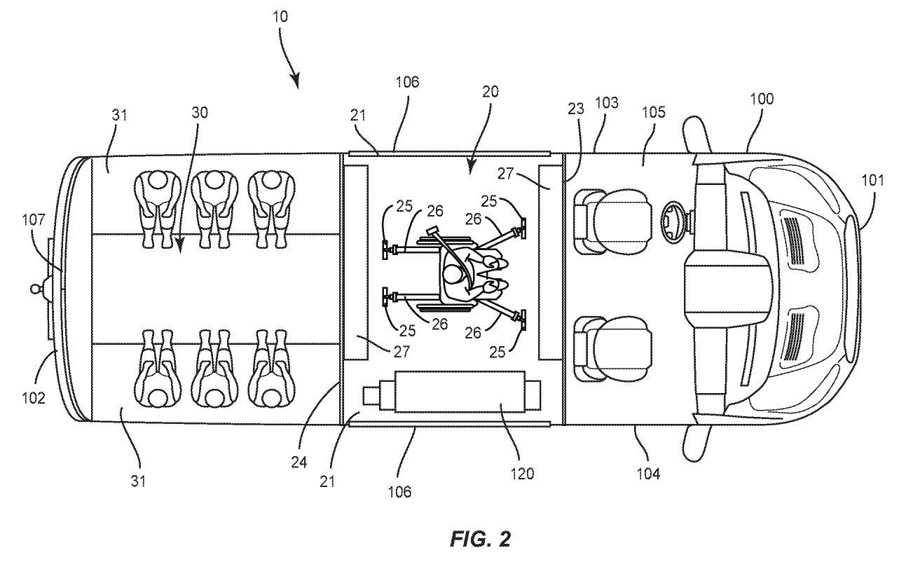

FIG. 2 illustrates a security system 10 positioned within an interior of a vehicle 100. The security system 10 includes a front wall 23 and a rear wall 24 that are spaced apart along the longitudinal length of the vehicle 100. The front wall 23 is configured to segregate the first secure holding area 20 from a driver area 105. The rear wall 24 is configured to segregate the first area 20 from a second area 30. The front and rear walls 23, 24 may be sized to extend between a floor and a ceiling of the interior of the vehicle 100, and from the first lateral side 103 to the second lateral side 104. One or both front and rear walls 23, 24 may include gaps between the ceiling, floor, and/or one or more of the lateral sides 103, 104. One or more windows may also be formed in one or both front and rear walls 23, 24.

The first holding area 20 is formed between the front and rear walls 23, 24. The first holding area 20 includes a first opening 21 at the lateral side 103 of the vehicle 100, and a second opening 22 at the opposing lateral side 104. The openings 21, 22 align with doors 106 on the vehicle sides 103, 104 of the vehicle 100. Thus, when the doors 106 are in an open position, a person has access into and out of the first holding area 20. When closed, a person is confined in the first area 20. The doors 106 can be sliding doors, or can be hinged to pivot between the open and closed positions.

The lateral sides of the first holding area 20 may be formed by the lateral sides 103, 104 of the vehicle 100. Thus, the walls 23, 24 are not connected together. In other designs, walls, supports, or similar extensions (not illustrated) extend between the walls 23, 24 and form one or both of the lateral sides.

The front wall 23 is longitudinally spaced apart from the rear wall 24. The front wall 23 is positioned in front of the doors 106 on the lateral sides 103, 104. The rear wall 24 is positioned behind the doors 106.

In the design of FIG. 2, the first holding area 20 is configured to house a person in a wheelchair. Mounts 25 are positioned on the floor to connect with straps 26 to secure the wheelchair. The mounts 25 may be positioned to secure the wheelchair in the center of the first holding area 20 (i.e., equally spaced from each of the lateral sides 103, 104).

One or more benches 27 may be positioned in the first holding area 20. The benches 27 may be attached to one or both walls 23, 24. The benches 27 may be movable between a first extended position for sitting, and a second folded position against the walls 23, 24 to provide additional space for housing the wheelchair.

The first holding area 20 may be sized to contain a lift 120. The lift 120 is configured to move a person and wheelchair into and out of the first holding area 20. The open lateral sides 103, 104 of the first holding area 20 facilitate placement and use of the lift 120.

The second holding area 30 is positioned between the rear wall 24 and the vehicle rear 102. One or more benches 31 may extend along the inner sides of the lateral walls 103, 104 such that the persons face each other. The second holding area 30 is further formed by the vehicle lateral walls 103, 104 and rear wall 102. A door 107 in the rear wall 108 provides ingress and egress for the second holding area 30.

The security system 10 utilizes portions of the vehicle 100 to form the first and second holding areas 20, 30. The lateral sides 103, 104 form the lateral sides of both of the first and second holding areas 20, 30. Further, the rear side 102 forms the rear wall of the second holding area 30. This design reduces the amount of material needed to form the enclosure and thus the overall weight of the security system 10.

Installation of the security system 10 into the vehicle 100 may occur during the original manufacturing of the vehicle 100, or may be a conversion of an existing vehicle 100. The installation may include attachment of the first wall 23 within the interior of the vehicle 100 behind the front seats of the driver area 105 (i.e., behind the driver and passenger seats). The attachment may include mechanical fasteners such as bolts, screws, rivets, and/or welded connections. The attachment may be to one or more of the vehicle floor, ceiling, rear wall, and lateral sides. The rear wall 24 is inserted and attached to the interior of the vehicle 100 in a similar manner. In the various designs, the walls 23, 24 are positioned on opposing sides of the lateral doors 106 of the vehicle 100. The walls 23, 24 may be spaced apart a variety of distances to adjust the size of the first holding area 20. The different sizes may be necessary to accommodate the specific vehicle and/or the needs of the transported person(s).

During use, a first person in a wheelchair can be secured in the first holding area 20. This may include using the lift 120 to position the person and wheelchair in this first holding area 20. The wheelchair is positioned, and the guard is able to use the straps 26 with the mounts 25 to secure the position. The guard is able to move into and out of the first holding area 20 through both open lateral sides 21, 22 and vehicle doors 106. Because of the open lateral sides 21, 22 and the two doors 106, the person is not positioned between the guard and the only means of exit from the first holding area 20. Additional persons may be loaded into the second holding area 30. These persons enter into the second holding area 30 through the rear door 107 and open rear side of the second holding area 30.

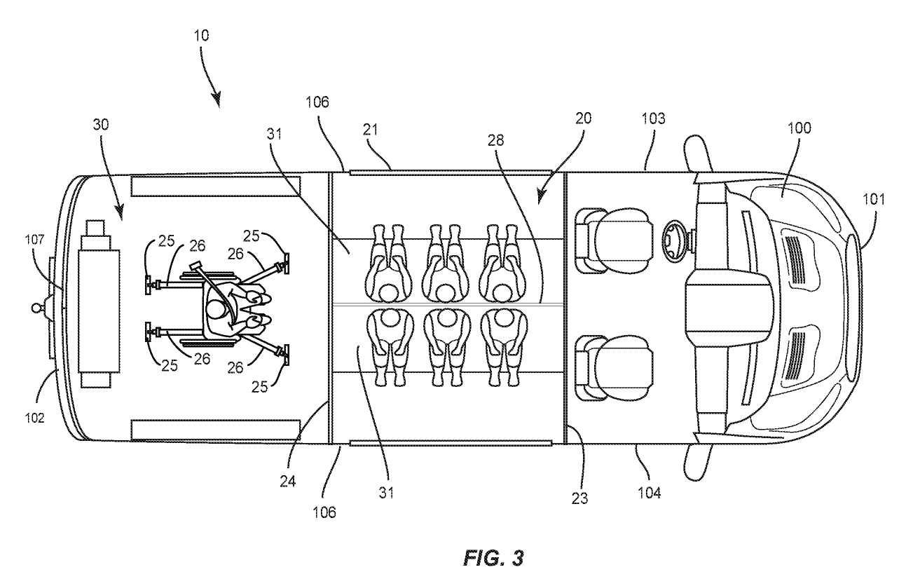

FIG. 3 includes another security system 10 with a first holding area 20 and a second holding area 30. The first holding area 20 is formed between the walls 23, 24, and the second holding area is formed between the rear wall 24 and the rear 102 of the vehicle 100. In this design, the first holding area 20 is equipped with a pair of benches 31 to house multiple persons. A wall 28 is positioned between the benches 31 and may form a back rest for the persons. The wall 28 may further completely segregate the first holding area 20 into separate sections. The wall 28 may be attached to and extend the complete distance between the walls 23, 24, and may extend completely between the floor and roof. Alternatively, the wall 28 may include gaps, extend less than the entire distance between the walls 23, 24 and/or between the ceiling and floor.

The first holding area 20 is again equipped with open lateral sides 21, 22 that align with doors 106 along the vehicle sides 103, 104. The double-opening design facilitates ingress and egress from the first holding area 20. The second holding area 30 is equipped to hold a wheelchair. Mounts 25 are attached to the floor and spaced apart to receive straps 26 for securing the wheelchair. The rear wall of the second area 30 is formed by the vehicle rear wall 102. The rear door 107 provides for ingress and egress to the second holding area 30.

The security system 10 can include a variety of different configurations. FIG. 2 includes a configuration with the first holding area 20 equipped for a wheelchair and the second holding area 30 equipped with bench seating. FIG. 3 includes the first holding area 20 equipped with bench seating and the second holding area 30 equipped for a wheelchair. A variety of other configurations can also be included to transport persons. One example includes each of the first and second holding areas 20, 30 equipped for a wheelchair. Another example includes each of the first and second holding areas 20, 30 equipped with bench seating.

The security system 10 is sized to fit within a variety of different vehicles. Examples of such vehicles include but are not limited to the Ford T350 and T250 cargo vans, the Chevrolet EXPRESS 3500 and EXPRESS 2500 cargo vans, the Dodge PROMASTER 3500 and PROMASTER 2500 cargo vans, the GMC SAVANA cargo van, and variety of trucks, vans, and sports utility vehicles.

The modular construction of the security system 10 facilitates the assembly and disassembly within the vehicle 100. The modular nature of the security system 10 also facilitates disassembly and removal in the event that the vehicle 100 is damaged or taken out of service.

The security system 10 provides a means of outfitting widely available transport vehicles 100 with an apparatus for the secure containment and transportation of persons. Sectional construction and the use of fasteners or other interlocking devices to interconnect the components also provides a non-permanent and reusable containment structure. Thus, the security system 10 is cost-effective in that specialized transport vehicles do not have to be purchased by the user as an ordinary commercially available vehicle is sufficient. Furthermore, if the vehicle 100 has been wrecked or once the service life of the vehicle 100 has been reached, the security system 10 may be removed and installed in another vehicle 100. Finally, the sectional construction facilitates modifications of selected components and customization of the structure to meet the requirements of different situations.

The security system 100 may also include a camera mounted to record one or both of the first and second holding areas 20, 30. The cameras may be positioned within the first and second holding areas 20, 30, or on the exterior of the areas 20, 30 and directed inward. In one design, cameras are mounted on one or more of the vehicle doors 106, 107. The doors include openings and/or windows through which the camera is aimed. The openings/windows further include a grill, transparent protective panel, or other like protective member to prevent access to the camera by a person within the first and second holding areas 20, 30.

The security system 10 may be constructed from different materials, including but not limited to high-density polyethylene (HDPE), and various metals. The security system 10 may be constructed from a single material, or combination of different materials.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A security system for use within a vehicle that includes first and second side doors on opposing lateral sides of the vehicle and a rear door on a rear of the vehicle, the security system comprising:
a front wall that extends between and is sized to contact against the opposing lateral sides of the vehicle at a first longitudinal position in front of the first and second side doors;
a rear wall that extends between and is sized to contact against the opposing lateral sides of the vehicle at a second longitudinal position behind the first and second side doors;
a first holding area formed between the front wall and the rear wall, the first holding area comprising a first open lateral side that aligns with the first side door and a second open lateral side that aligns with the second side door;
a second holding area formed between the rear wall and the rear door of the vehicle, the second holding area comprising an open rear that aligns with the rear of the vehicle; and
the first holding area being independent from the second holding area to isolate a first person in the first holding area from a second person in the second holding area.

2. The security system of claim 1, further comprising first and second benches that extend longitudinally within one of the first and second holding areas.

3. The security system of claim 2, wherein the first bench extends along a first lateral side of the vehicle and the second bench extends along a second lateral side of the vehicle, the first and second benches being spaced apart with an aisle formed between the first and second benches.

4. The security system of claim 2, wherein the first and second benches are each positioned along a longitudinal center of the vehicle in a back-to-back orientation with the first bench facing the first lateral side of the vehicle and the second bench facing the second lateral side of the vehicle.

5. The security system of claim 4, further comprising a longitudinal wall positioned between the first and second benches, the longitudinal wall extends between a floor and a ceiling of one of the first and second holding areas.

6. The security system of claim 2, further comprising mounts connected to a floor of the vehicle and straps that extend from the mounts to secure a wheelchair within one of the first and second holding areas.

7. The security system of claim 6, further comprising at least one folding bench positioned adjacent to the mounts and the straps, the folding bench movable between a stowed orientation and an extended orientation.

8. A method of installing a security system within a vehicle, the method comprising:
attaching a front wall within an interior of the vehicle at a first longitudinal position that is in front of first and second side doors of opposing lateral sides of the vehicle and contacting the front wall against the opposing lateral sides of the vehicle;
attaching a rear wall within the interior of the vehicle at a second longitudinal position that is behind the first and second side doors and contacting the rear wall against the opposing lateral sides of the vehicle;
forming a first holding area between the front wall and the rear wall and aligning a first open lateral side with the first side door and aligning a second open lateral side with the second side door; and
forming a second holding area between the rear wall and a rear of the vehicle and aligning an open side with a rear door on the rear of the vehicle.

9. The method of claim 8, further comprising positioning the rear wall across the interior of the vehicle and isolating the first holding area from the second holding area.

10. The method of claim 8, further comprising attaching a longitudinal wall between the front wall and the rear wall and isolating a first section of the first holding area that faces towards the first open lateral side from a second section of the first holding area that faces towards the second open lateral side.

11. The method of claim 10, further comprising attaching a first bench to the longitudinal wall in the first section of the first holding area and attaching a second bench to the longitudinal wall in the second section of the second holding area.

12. The method of claim 10, further comprising connecting mounts and straps to a floor of the vehicle within the second holding area, the mount and straps configured to secure a wheelchair within the second holding area.

13. The method of claim 8, forming the first holding area to be open between the first and second open lateral sides to prevent a security personnel from becoming trapped within the first holding area.

14. The method of claim 8, further comprising attaching a first bench to the first lateral side of the vehicle within the second holding area and attaching a second bench to the second lateral side of the vehicle within the second holding area and forming an open aisle between the first and second benches.

15. The method of claim 14, further comprising aligning each of the first and second benches transverse to the rear of the vehicle.

16. A method of installing a security system within an interior of a vehicle, the method comprising:
forming a first holding area in the vehicle and aligning a first open lateral side of the first holding area with a first lateral side door of the vehicle and a second open lateral side of the first holding area with a second lateral side door of the vehicle;
forming a second holding area in the vehicle behind the first holding area, the second holding area having an open rear side that aligns with a rear door of the vehicle and the second holding area being isolated from the first holding area by a rear wall; and
using the lateral side walls of the vehicle as lateral side walls of each of the first and second holding areas.

17. The method of claim 16, wherein forming the first holding area comprises attaching a front wall across the interior of the vehicle and attaching the rear wall across the interior of the vehicle with the front and rear walls being longitudinally spaced apart.

18. The method of claim 17, further comprising mounting first and second benches in the first holding area with the first bench facing towards the first lateral side door of the vehicle and the second bench facing towards the second lateral side door of the vehicle.

19. The method of claim 18, further comprising positioning an intermediate wall between the first and second benches and attaching the intermediate wall to each of the front wall and the rear wall.

20. The method of claim 16, further comprising positioning a first bench against one of the lateral side walls in the second holding area and positioning a second bench against the other of the lateral side walls in the second holding area.
